(19) United States
(12) Patent Application Publication
(10) Pub. No.: US 2020/0253404 A1
(43) Pub. Date: Aug. 13, 2020

(54) Foldable Drinking Straws, Cleaning Elements, and Related Storage Cases

(71) Applicant: The Final Co., LLC, Santa Fe, NM (US)

(72) Inventors: Emma R. Cohen, Santa Fe, NM (US); John Stump, Santa Barbara, CA (US); Miles Pepper, Los Angeles, CA (US)

(21) Appl. No.: 16/862,254

(22) Filed: Apr. 29, 2020

Related U.S. Application Data
(63) Continuation-in-part of application No. 16/548,410, filed on Aug. 22, 2019, now Pat. No. 10,660,464.
Application No. 16/548,410 is a continuation of application No. 16/186,560, filed on Nov. 11, 2018.
Application No. 16/186,560 is a continuation of application No. 15/987,681, filed on May 23, 2018, now Pat. No. 10,123,641.
(60) Provisional application No. 62/658,976, filed on Apr. 17, 2018.
(60) Provisional application No. 62/579,013, filed on Oct. 30, 2017.
(60) Provisional application No. 62/840,517, filed on Apr. 30, 2019.

(51) Int. Cl. A47G 21/18; B65D 81/26; A47L 17/00; B08B 9/043; B08B 1/00

(52) U.S. Cl. CPC A47G 21/189; B65D 81/261; B08B 1/005; B08B 9/0436; A47L 17/00

(57) ABSTRACT

Foldable drinking straws, cleaning elements, and related storage cases are disclosed. In accordance with a first example, a system for drinking liquids includes a storage case, a reusable drinking straw, and a cleaning element. The storage case has a lid and a base defining an internal cavity that includes a straw storing area and a cleaning element storing area. The reusable drinking straw includes a flexible tube having a passageway, a proximal end, and a distal end. The reusable drinking straw is configured to move from a folded configuration to an extended configuration based on an elasticity of the flexible tube. The cleaning element includes a brush and being disposable within the cleaning element storing area and adapted to clean the passageway of the flexible tube.

### RELATED APPLICATION

This disclosure claims the benefit of U.S. Provisional Patent Application No. 62/840,517, filed Apr. 30, 2019, and is a continuation-in-part of U.S. patent application Ser. No. 16/548,410 filed Aug. 22, 2019, which is a continuation of U.S. patent application Ser. No. 16/186,560, filed Nov. 11, 2018, which is a continuation of U.S. patent application Ser. No. 15/987,681, filed May 23, 2018, which claims the benefit of U.S. Provisional Patent Application No. 62/658,976, filed Apr. 17, 2018, and claims the benefit U.S. Provisional Patent Application No. 62/579,013, filed Oct. 13, 2017. The entire contents of each of the foregoing being incorporated by reference herein.

### BACKGROUND

Over 500,000,000 plastic straws are used each day in the United States and are then disposed of after a single use. In only the past twenty years, people have come to expect plastic straws in every drink, in an example of extreme waste being generated for convenience. These short-lived tools are usually dropped into a garbage with no further thought, instantly becoming a source of plastic pollution. (http://www.plasticpollutioncoalition.org/no-straw-please/)

The consumption of 500 million single-use plastic straws a day is enough straws to wrap around the circumference of the earth 2.5 times per day. Currently, it is nearly impossible to recycle plastic straws, which often end up in a dump. Plastic straws are also swept away by winds and end up in waterways, and eventually into the oceans. Plastic straws are confused as food by fish and seabirds. In a recent study, it was estimated that approximately 60% of seabirds currently have plastic in their stomachs, and by 2050, 99% percent of seabirds will have plastic in their stomachs.

In effort to combat this massive environmental problem, single-use plastic straws are being banned in restaurants, cafes and bars all around the world. For example, the city of Seattle, Wash. has banned all plastic straws as of Jan. 1, 2018. Other countries, states, and cities are in the process of implementing similar bans of single-use plastic straws. Despite governmental efforts and increased public awareness of the environmental problems caused by single-use plastic straws, plastic straws are still being served in many places.

One solution to not using plastic straws is for people to carry their own, reusable straws. But the problem is that reusable straws are often made out of glass or metal, and by nature are long and inconvenient to carry around. Glass straws are easy to break and need a bulky case to keep them from snapping. If people are to bring reusable straws everywhere, they will want somewhere clean to put the reusable straw. That means keeping the reusable straw in a case that is even bigger and bulkier than the glass and metal straws in their current form.

Therefore, there exists a need for a convenient reusable drinking straw that is easy to carry, store, and easy to clean.

### SUMMARY

The disclosed examples are directed to a reusable drinking straw that is foldable into a compact configuration for storage and easily transportable in a storage case. The straw includes a rigid external tube and a flexible internal tubing that is foldable to a compact configuration for storage. In a folded configuration, the reusable straw may have a significantly reduced length of approximately one-half to one-fourth of its extended length when in use. The external tube of the straw is preferably formed of multiple rigid segments for supporting the flexible internal tubing in the extended configuration during use as a drinking straw. The rigid segments are separable from one another and slideable along the flexible internal tubing. The rigid segments may be configured to be at least in part in the shape of a portion of a cylinder or tube to at least partially surround a portion of the flexible tube. A cleaning device is provided to clean the straw after use. A storage case is provided to store the straw in the folded configuration in a compact form and to store the cleaning device.

In an example, the reusable drinking straw that is foldable for storage has a rigid external tube formed of a plurality of tubular segments. The external tube has a proximal end, an opposite distal end, a hollow interior, and a central longitudinal axis passing through the ends of the external tube. The hollow interior is accessible through the ends and has an interior diameter. Each of the tubular segments is configured to be coupled to at least another one of the tubular segments when positioned adjacent to one another along the central longitudinal axis of the external tube to form the external tube.

A flexible internal tubing is positioned within the external tube. The flexible internal tubing has a proximal end, an opposite distal end, and a passageway accessible through the ends of the internal tubing. The internal tubing is formed of an elastic material for conducting liquid through the passageway and is impermeable to liquids. The internal tubing is positioned within the external tube with the proximal and distal ends of the internal tubing proximate to the proximal and distal ends, respectively.

The drinking straw is in an extended configuration when at least two of the tubular segments are coupled together to form the rigid external tube with the flexible internal tubing therethrough. The internal tubing is under tension within the external tube to maintain the tubular segments coupled together. The elastic nature of internal tubing, returning from a stretched state in the folded configuration to a less-stretched state in the extended configuration, functions to essentially automatically extend and reconfigure the drinking straw to the extended configuration.

The drinking straw is in a folded configuration when at least two of the tubular segments are uncoupled from one another and moved apart along the flexible internal tubing by stretching the internal tubing and folding the internal tubing between at least two tubular segments.

A cleaning element is provided that is configured to clean the passageway of the flexible internal tubing of the drinking straw. The cleaning element may include a telescopic handle with a brush sized and configured to pass through the passageway of the flexible tubing of the drinking straw.

A storage case is provided that is configured to contain the drinking straw and store the cleaning element. The storage case contains the drinking straw in the folded configuration. The storage case also stores the cleaning element. The storage case includes a first area for storing the drinking straw and second area for storing the cleaning element.

In accordance with a first example, a system for drinking liquids includes a storage case, a reusable drinking straw, and a cleaning element. The storage case has a lid and a base defining an internal cavity that includes a straw storing area and a cleaning element storing area. The reusable drinking straw includes a flexible tube having a passageway, a proximal end, and a distal end. The reusable drinking straw is configured to move from a folded configuration to an extended configuration based on an elasticity of the flexible tube. When in the folded configuration, the reusable drinking straw has a plurality of segments arranged beside one another and that are disposable within the straw storing area and, when in the extended configuration, the reusable drinking straw is generally linear. The cleaning element includes a brush and being disposable within the cleaning element storing area and adapted to clean the passageway of the flexible tube.

In accordance with a second example, a system for drinking liquids includes a storage case, a reusable drinking straw, and a cleaning element. The storage case has a lid and a base defining an internal cavity that include a straw storing area and a cleaning element storing area. The reusable drinking straw includes a flexible tube having a passageway, a proximal end, and a distal end and a plurality of tubular segments that are disposed between the proximal end and the distal end and through which the flexible tube extends. The reusable drinking straw is configured to move from a folded configuration to an extended configuration based on an elasticity of the flexible tube. In the folded configuration, the plurality of tubular segments are arranged beside one another and are disposable within the straw storing area and, in the extended configuration, the plurality of tubular segments are generally arranged end-to-end. The cleaning element includes a brush and is disposable within the cleaning element storing area and is adapted to clean the passageway of the flexible tube.

In further accordance with the foregoing first example, an apparatus may further include any one or more of the following:

In accordance with an example, a removable coupling is formed between the cleaning element and the storage case when the cleaning element is disposed within the cleaning element storing area.

In accordance with another example, the removable coupling is a magnetic coupling.

In accordance with another example, the cleaning element includes a cleaning element magnet and the storage case includes a storage case magnet that is attracted to the cleaning element magnet.

In accordance with another example, the cleaning element is movable between a collapsed position and an extended position. The attraction between the cleaning element magnet and the storage case magnet allows the cleaning element to be moved from the collapsed position to the extended position while retaining a relative position of the brush within the cleaning element storing area.

In accordance with another example, the cleaning element has an end that includes the cleaning element magnet.

In accordance with another example, a snap-fit connection is formed between the cleaning element and the storage case when the cleaning element is disposed within the cleaning element storing area.

In accordance with another example, the cleaning element includes a telescopic handle coupled to the brush. The handle is movable between a collapsed position for storage within the cleaning element storing area and an extended position to clean the passageway of the flexible tube.

In accordance with another example, the handle has a proximal end having a grasping flange.

In accordance with another example, the handle has a proximal end having a shoulder that is adapted to engage the proximal end or the distal end of the flexible tube.

In accordance with another example, the straw storing area is contiguous with the cleaning element storing area.

In accordance with another example, the base has a front wall that defines an internal longitudinal groove that at least partially forms the cleaning element storing area.

In accordance with another example, the base of the storage case has an internal wall that separates the straw storing area and the cleaning element storing area.

In accordance with another example, a magnetic coupling is formed between the lid and the base when the lid is in a closed position.

In accordance with another example, the base defines an inner circumferential groove at an opening of the internal cavity and the lid includes a rib that is adapted to be received within the circumferential groove and form a seal when the lid is in a closed position.

In accordance with another example, the lid includes a key ring.

In accordance with another example, the flexible tube is under tension within the plurality of tubular segments.

In accordance with another example, the flexible tube is in a stretched state in the folded configuration and the flexible tube is in a less-stretched state in the extended configuration.

In accordance with another example, in the extended configuration, the plurality of tubular segments are generally coaxially arranged.

In accordance with another example, the proximal end and the distal end of the flexible tube are adapted to interlock with corresponding ends of the plurality of tubular segments when the reusable drinking straw is in the extended position.

In accordance with another example, the proximal end and the distal end of the flexible tube and corresponding tubular segments form a male-female coupling when the reusable drinking straw is in the extended position.

In accordance with another example, adjacent ones of the plurality of tubular segments are adapted to interlock when the reusable drinking straw is in the extended configuration.

In accordance with another example, the adjacent ones of the plurality of tubular segments include an anti-rotation feature that prevents individual rotation of the plurality of tubular segments.

In accordance with another example, the anti-rotation feature includes a ridge on one of the adjacent ones of the plurality of tubular segments and a channel on another one of the adjacent ones of the plurality of tubular segments.

In accordance with another example, a male-female coupling is formed between each of the plurality of tubular segments when the reusable drinking straw is in the extended configuration.

In accordance with another example, in the folded configuration, the plurality of tubular segments are parallel to one another.

In accordance with another example, each of the plurality of tubular segments is rigid.

### BRIEF DESCRIPTION OF THE DRAWINGS

FIG. 1 shows a top, front, right side perspective view of a system for drinking liquids in accordance with a first example of the present disclosure.

FIG. 2 is an expanded top, front, right side perspective view of the system including the storage case, the straw, and the cleaning element of FIG. 1.

FIG. 3 is an expanded isometric view of the straw of FIG. 1 in the partially extended configuration.

FIG. 4 is an isometric view of the straw of FIG. 1 in the expanded configuration.

FIG. 5 is an enlarged cross-sectional view of the proximal end of the tube and one of the tubular segments of the straw of FIG. 1.

FIG. 6 is an isometric view of the cleaning element of FIG. 1 in the extended position.

FIG. 7 is an isometric view of the storage case of FIG. 1 with the lid in the closed position.

FIG. 8 is a rear view of the storage case of FIG. 7.

### DETAILED DESCRIPTION

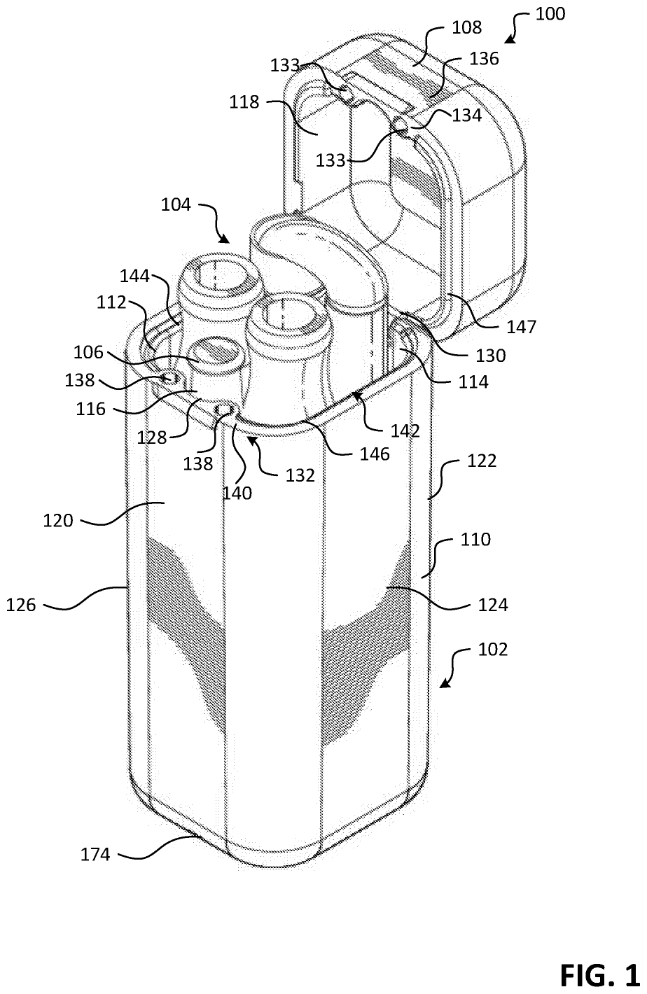

Referring now to the drawings, FIG. 1 shows a top, front, right side perspective view of a system 100 for drinking liquids in accordance with a first example of the present disclosure. The system 100 includes a storage case 102, a reusable drinking straw 104, and a cleaning element 106. Generally, the straw 104 is used to suck/drink liquids and the cleaning element 106 is used to clean the straw 104 after and/or before use. The straw 104 and the cleaning element 106 are collapsible for storage within the storage case 102. Thus, the storage case 102 storing the straw 104 and the cleaning element 106 may be easily carried on, for example, a key chain or in a pocket, for convenient and accessible use. The storage case 102 may have a width of approximately 2.6 centimetres (cm) and a height of approximately 7 cm. Other sizes may prove suitable.

In the example shown, the storage case 102 has a lid 108 and a base 110 that defines an internal cavity 112 that includes a straw storing area 114 and a cleaning element storing area 116. The straw storing area 114 is adapted to store the straw 104 and may have a depth of about 5.25 cm and the cleaning element storing area 116 is adapted to store the cleaning element 106 and may have a depth of about 5.25 cm. The straw storing area 114 is shown being contiguous with the cleaning element storing area 116. However, the storing areas 114, 116 may be separated by, for example, an internal wall.

The lid 108 also defines an internal cavity 118 that may be positioned overtop of and receive the straw 104 and the cleaning element 106 when the lid 108 is in the closed position. Thus, when the lid 108 is in the open position, the straw 104 and the cleaning element 106 protrude from the base 110 and allow a user to easily grasp and remove the items from the base 110.

The base 110 has a front wall 120, a back wall 122, and side walls 124, 126 that together define the internal cavity 112. The walls 120, 122, 124, 126 of the base 110 may retain the straw 104 in the folded configuration when the straw 104 is received within the straw storing area 114.

The front wall 120 defines an internal longitudinal groove 128 that at least partially forms the cleaning element storing area 116. A hinge 130 is formed between the back wall 122 and the lid 108 and may include a pin or may be a living hinge. Other types of hinges may prove suitable.

A magnetic coupling 132 may be formed between the lid 108 and the base 110 when the lid 108 is in the closed position (see, for example, FIG. 9). To form the magnetic coupling 132, a pair of magnets 133 are coupled to a lower face 134 of a front wall 136 of the lid 108 and a corresponding pair of magnets 138 are coupled to an upper face 140 of the front wall 120 of the base 110. While two magnets are shown on each surface 134, 140, any number of magnets may be used instead or the magnets 133, 138 may be omitted.

Additionally, a seal 142 may be formed between the lid 108 and the base 110 when the lid 108 is in the closed position. To form the seal 142, the base 110 may define an inner circumferential groove 144 at an opening 146 of the internal cavity 112 that is adapted to receive a corresponding rib 147 that protrudes from the lower face 134 of the lid 108. The rib 147 may be an O-ring or a protrusion formed of the same material as the lid 108. If the rib 147 is an O-ring, the lid 108 may define a groove into which the O-ring seats.

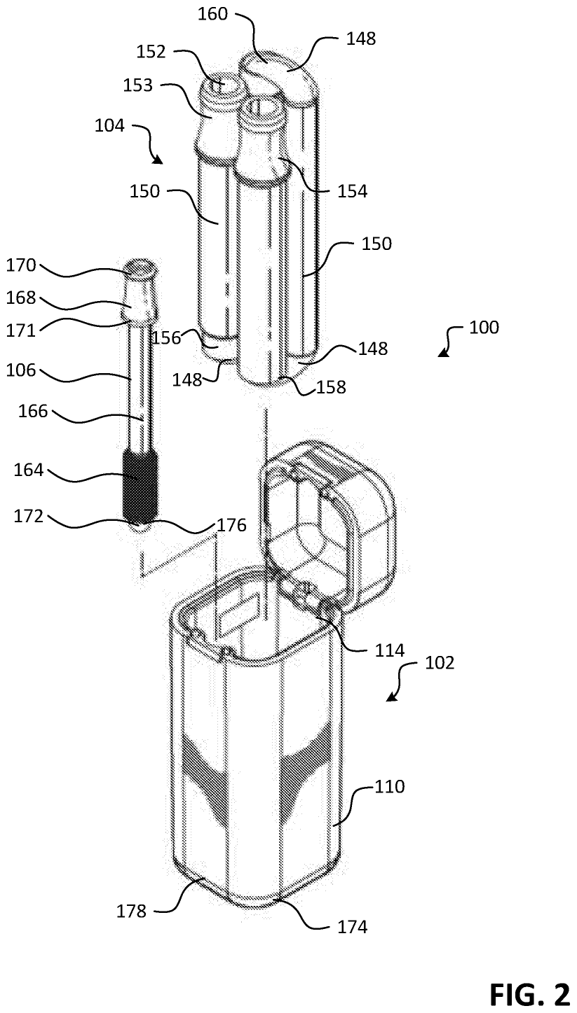

FIG. 2 is an expanded top, front, right side perspective view of the system 100 including the storage case 102, the straw 104, and the cleaning element 106 of FIG. 1. Referring to the straw 104, in the example shown, the straw 104 includes a flexible tube 148 and a plurality of tubular segments 150 through which the tube 148 extends. The flexible tube 148 includes a passageway 152 that extends between a proximal end 153 and a distal end 154 of the tube 148 to allow liquid to be drawn through the tube 148. The ends 153, 154 of the tube 148 are tips having a frustoconical shape. However, the ends 153, 154 may have any other shape.

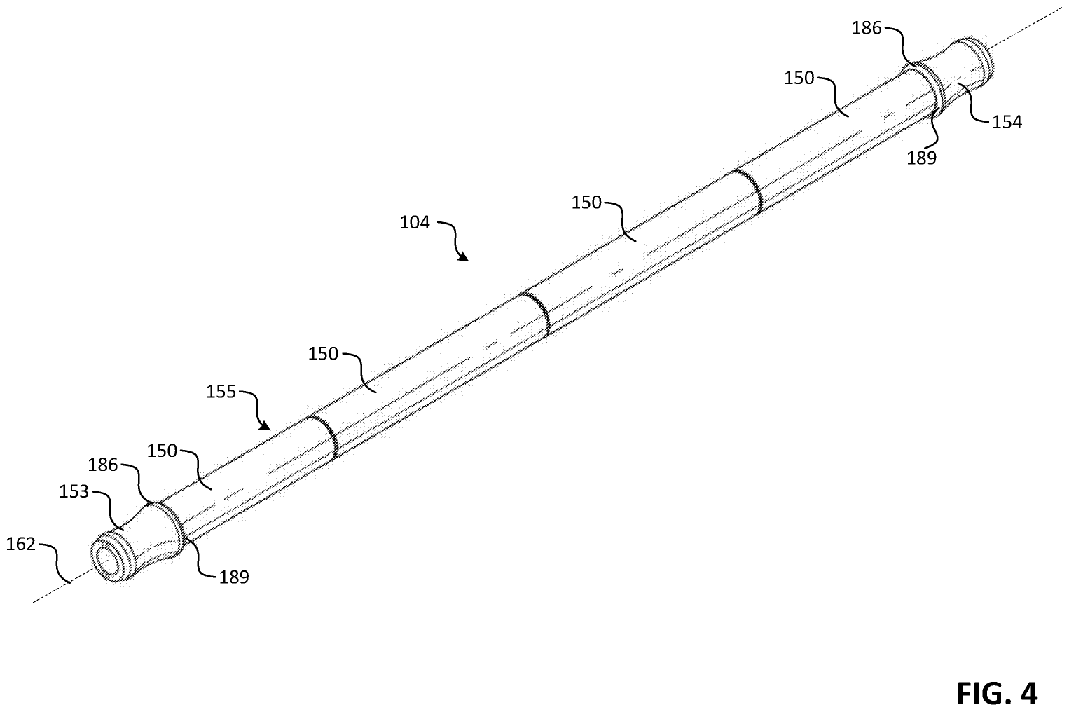

The tubular segments 150 are rigid and may be configured to be coupled to at least another one of tubular segments 150 when positioned adjacent to one another forming an external tube 155 (See, FIG. 4). In the example shown, the tubular segments 150 include male portions 156 and female portions 158 that form a male-female coupling and/or otherwise allow the tubular segments 150 to interconnect to form the external tube 155 when the straw 104 is in the extended configuration. In another example, the portions 156, 158 of the tubular segments 150 may form a snap-fit connection.

The portions 156 and/or 158 may also include an anti-rotation feature that prevents the tubular segments 150 from individually rotating when the straw 104 is in the extended configuration. The anti-rotation feature may include a ridge on one of the portions 156 or 158 of the tubular segments 150 and a channel on the other of the portions 156 or 158 of the tubular segments 150 that is adapted to receive the ridge. However, the tubular segments 150 may include other structure(s) to deter rotation from occurring or the anti-rotation feature may be omitted.

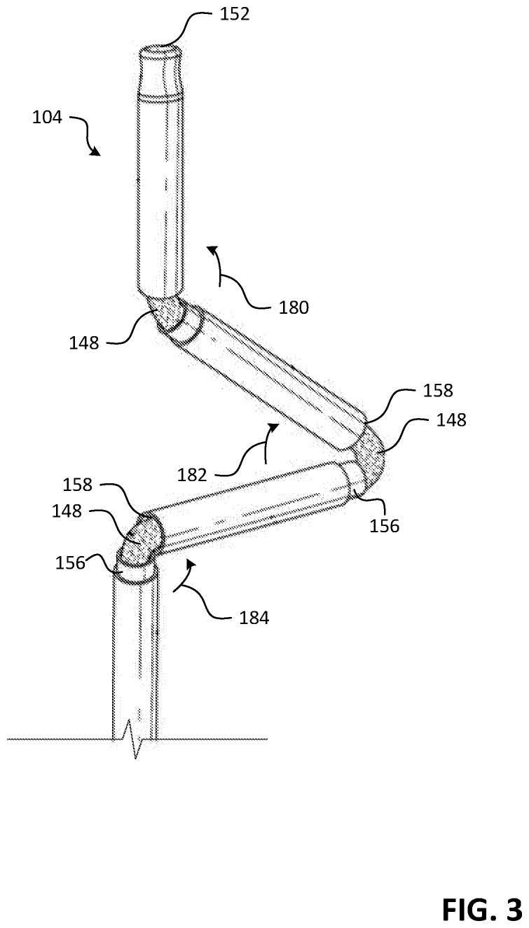

In FIG. 2, the straw 104 is shown in a folded configuration with the tubular segments 150 arranged besides one another (e.g., substantially parallel to one another) to allow the straw 104 to be received within the straw storing area 114. As set forth herein, the phrase “substantially parallel” means+/−10° of parallel. Based on an elasticity of the tube 148, the tubular segments 150 and the tube 148 may automatically move from the folded configuration shown, to a partially extended configuration shown in FIG. 3 and to the fully extended configuration shown in FIG. 4. When the straw 104 is in the folded configuration, the tube 148 is in a stretched state and, when the straw 104 is in the extended configuration, the flexible tube 148 is in a less-stretched state. Thus, the tube 148 urges the straw 104 to move from the folded configuration to the extended configuration.

In the extended configuration, the tubular segments 150 are arranged end-to-end and may be coaxial to allow the straw 104 to be used to drink liquid, such as those with different viscosities, densities, and/or temperatures. The temperature of the liquid may be hotter than ambient temperature or colder than ambient temperature. The viscosity and/or density of the liquid may be different than water including thicker liquids such as, for example, juices, smoothies, shakes, and/or bubble teas such as Boba for example, and that may be at least partially frozen. The liquid may also include a mixture with other ingredients suspended therein suitable for drinking through the straw 104.

In some examples, the tube 148 is formed of an elastic material suitable for drinking and conducting liquid through the tube 148 and is impermeable to liquids to prevent leakage along its length. The tube 148 may be sufficiently elastic and flexible to be stretchable along a central longitudinal axis 162 (see, FIG. 4) of the straw 104 to maintain the tubular segments 150 under tension and to be further stretchable to allow separation of the tubular segments 150 and folding of the tube 148 between two separated tubular segments 150. A central body portion 160 of the tube 148 has a smaller cross-section (diameter) than the ends 153, 154 of the tube 148 allowing the central body portion 160 to pass through the tubular segments 150.

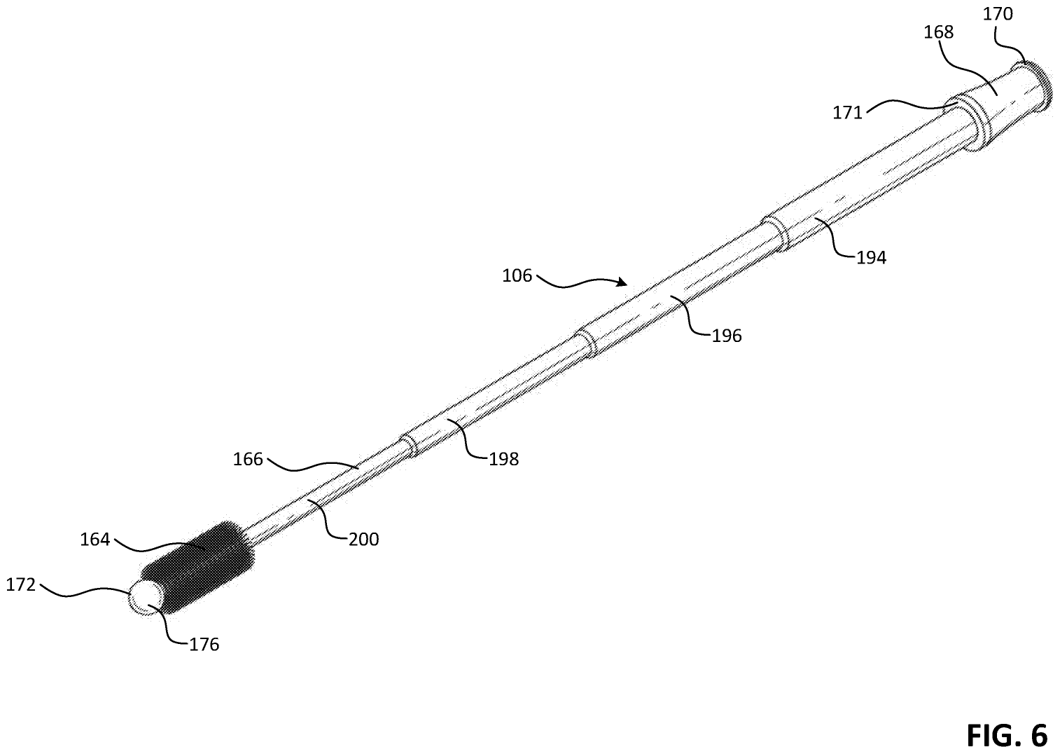

Referring to the cleaning element 106, the cleaning element 106 includes a brush 164 that is adapted to clean the passageway 152 of the tube 148. In the example shown, the cleaning element 106 also has a telescopic handle 166 that is coupled to the brush 164 and is movable between a collapsed position shown in FIG. 2 and an extended position shown in FIG. 6 to allow the cleaning element 106 to clean the passageway 152 of the tube 148. In the extended position, the cleaning element 106 may have a length that is greater than half of the length of the straw 104 in the extended position to allow the entire length of the straw 104 to be cleaned after the cleaning element 106 is inserted into the tube 148 from both ends 153, 154 of the tube 148.

The handle 166 has a proximal end 168 having a grasping flange 170 that allows a user to easily grasp and remove the handle 166 from the cleaning element storing area 116. The proximal end 168 of the handle 166 also has a shoulder 171 that is adapted to engage the ends 153, 154 of the tube 148 when the tube 148 is being cleaned by the brush 164. As a result of the engagement between the shoulder 171 and the ends 153 and/or 154 of the tube 148, the cleaning element 106 is unlikely to become stuck within the tube 148. In the example shown, the proximal end 168 of the cleaning element has a frustoconical shape and is similar in appearance to the ends 153, 154 of the tube 148. However, the proximal end 168 of the cleaning element 106 may have a different shape.

When the cleaning element 106 is removed from the storage case 102, a distal end 172 of the cleaning element 106 may remain temporarily coupled to a bottom wall 174 of the base 110 to allow the cleaning element 106 to telescopically extend into the extended position as the cleaning element 106 is being removed from the storage case 102. Once the cleaning element 106 is in the extended position, the coupling between the distal end 172 of the cleaning element 106 and the base 110 may be released allowing the cleaning element 106 to be used to clean the straw 104. Advantageously, the removable coupling formed between the cleaning element 106 and the base 110 allows a user to move the cleaning element 106 from the collapsed position to the extended position with one hand while the cleaning element 106 is being removed from the storage case 102.

The removable coupling may be a magnetic coupling where the end 172 of the cleaning element 106 includes a cleaning element magnet 176 and the storage case 102 includes a storage case magnet 178 that is attracted to the cleaning element magnet 176. Alternatively, one of the magnets 176, 178 may be a metal material (e.g., a ferromagnetic material) that is attracted to the magnet 176 or 178. However, other types of removable couplings may prove suitable or a removable coupling may not be provided. For example, a removable snap-fit connection may be formed between the end 172 of the cleaning element 106 and a corresponding socket may be formed within the cleaning element storing area 116 by the bottom wall 174 of the base 110. The end 172 of the cleaning element 106 is bulbous shaped but other shapes may prove suitable.

The tube 148 may be formed of materials including plastics, non-recycled plastics, thermoplastic elastomers (TPE), thermoplastic polyurethane (TPU), silicones, natural rubbers including latex, plant-based plastics, and/or other recyclable and/or renewable materials. In some examples, the tube 148 is made of food grade silicone. FDA certified food grade silicone is food safe, heat safe, soft, hydrophobic, temperature resistant between about −76 and about 500 degrees Fahrenheit, dishwasher safe, and/or available in many colors. Silicone is also inexpensive, flexible, feels better than bare metal on teeth, easy to clean, does not contain Bisphenol A (BPA), bacteria resistance, boiled to sterilize, durable, resists moisture, and/or instantly cools. The tube 148 may include, be treated with, or formed at least in part of an antibacterial material or substance.

The tubular segments 150 may be formed of materials including at least one of stainless steel, titanium, other metals, carbon fiber, composite materials, wood, non-recycled plastics, plant-based plastics, and/or other recyclable and/or renewable materials. For example, the tubular segments 150 may be formed of Stainless steel or Titanium. Stainless steel is biocompatible, does not rust, is recyclable, strong, upcycled stainless steel, and/or may be laser engraved in black. Titanium is also biocompatible, does not rust, is recyclable, highly strong/weight ratio, upcycled titanium supplier, strong, and/or has the ability to have laser engraving in color. Alternatively, any sufficiently rigid material may be used for the tubular segments 150 including plastics and/or composite materials. The tubular segments 150 can be engraved (e.g., laser engraved) with logos, designs, and/or artwork. The tubular segments 150 may be thermo-insulated to reduce heat transfer to a user when the straw 104 is used with a hot liquid such as coffee.

One or more of the tubular segments 150 may have an inner diameter of approximately 7 mm and can be in the range of about 2 mm and about 30 mm with an inner diameter as measured at the female connection of approximately 8 mm and an inner diameter as measured at the male connection of approximately 7 mm.

One or more of the tubular segments 150 may have a maximum outer diameter of approximately 9 mm and can be in the range of about 3 mm and about 35 mm; and at least one of tubular segments 150 may have a length of approximately 5 cm and can be in the range of between about 2.5 cm and about 16.5 cm. However, the tubular segments 150 may have any other diameter (e.g., an inner diameter, an outer diameter) or length including diameters and/or lengths that are different from one or more other ones of the tubular segments 150. An inner diameter of the tube 148 and/or the tubular segments 150 may be associated with a drink being consumed. In some examples, the tube 148 and the tubular segments 150 may have a larger diameter if the straw 104 is being used to drink a smoothie or for a drink including solid portions (e.g., Boba pearls).

In an example, the straw 104 has an external length of approximately 23 cm and the tube 148 has an un-stretched length of approximately 14 cm. The tube 148 may have an inner diameter that is approximately 5.0 mm and can be in the range of between about 2 mm and about 29 mm, for example. The tube 148 may have an outer diameter that is approximately 7.1 mm and may have a wall thickness of approximately 1.2 mm and can be in the range of between about 0.5 mm and about 5 mm. Other thicknesses of the tube 148 may prove suitable.

While the tubular segments 150 are shown having a circular cross section, the tubular segments 150 may have a different cross-section such as, for example, an oval cross section, a triangular cross section, and/or a rectangular cross section. While the tube 148 is shown having a circular cross-section, the tube 148 may have a different cross-section such as an oval cross section, a triangular cross section, and a rectangular cross section. Other cross-sections of the tubular segments 150 and/or the tube 148 may prove suitable.

FIG. 3 is an expanded isometric view of the straw 104 in the partially extended configuration. In the example shown, the tube 148 is urging the tubular segments 150 in directions generally indicated by arrows 180, 182, 184 and toward the extended position. FIG. 3 also shows the male portions 156 and the female portions 158 of the tubular segments 150 that are configured to mate and form male-female couplings.

FIG. 4 is an isometric view of the straw 104 in the expanded configuration. In the example shown, each of the proximal end 153 and the distal end 154 of the tube 148 include shoulders 186, 188 that abut a corresponding one of the tubular segments 150 to retain the relative position of the tubular segments 150 and keep the tube 148 in tension.

To allow the straw 104 to automatically extend and reconfigure into the extended position, in the example shown, the proximal end 153 and the distal end 154 of the tube 148 each abut one of the tubular segments 150 to place the tube 148 in tension. By keeping the tube 148 in tension, the tubular segments 150 may be held together in the extended configuration. To move the straw 104 from the extended configuration to the folded configuration, the tubular segments 150 may be pulled apart to stretch the tube 148, disengage the male-female coupling between the tubular segments 150, and allow the tubular segments 150 to be arranged next to one another with the tube 148 extending between the tubular segments 150.

To wash the straw 104, the straw 104 may be pulled apart on the ends 153, 154 of the tube 148 to extend the tube 148 from the tubular segments 150 and create a space between the tube 148 and an interior of the external tube 155. Water or another cleaning solution may be run through ends 189 of the external tube 155 to clean out debris or liquid present between the tube 148 and external tube 155 and/or between tubular segments 150. Water from a faucet can be run through the ends 189 and along the length of the straw 104 to flush out debris. Other methods of cleaning the straw 104 may prove suitable.

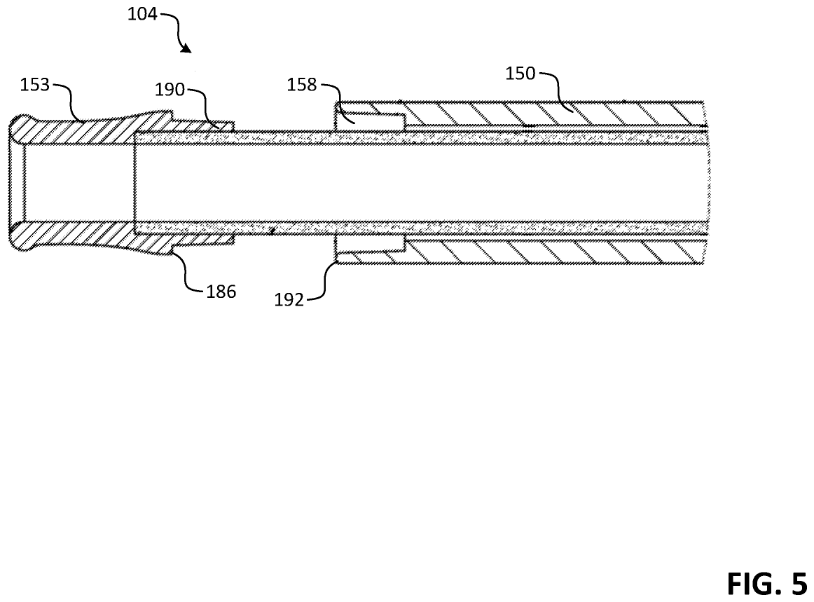

FIG. 5 is an enlarged cross-sectional view of the proximal end 153 of the tube 148 and one of the tubular segments 150. In the example shown, the proximal end 153 of the tube 148 is adapted to interlock (e.g., interdigitate) with the tubular segment 150 when the straw 104 is in the extended configuration. To enable the proximal end 153 of the tube 148 and the tubular segment 150 to interlock, the proximal end 153 includes a male portion 190 that is configured to be received within the corresponding female portion 158 of the tubular segment 150. When a male-female coupling is formed between the tube 148 and the tubular segment 150, the shoulder 186 of the proximal end 153 engages an end 192 of the tubular segment 150.

FIG. 6 is an isometric view of the cleaning element 106 in the extended position. In the example shown, the handle 166 includes a plurality of handle segments 194, 196, 198, 200 that are telescopically coupled, with the handle segment 200 adjacent the distal end 172 of the cleaning element 106 including the brush 164. A length of the cleaning element 106 in the extended position may be longer than half of the length of the tube 148. As a result of the length of the cleaning element 106, an entire length of the tube 148 may be cleaned by inserting the cleaning element 106 into the tube 148 from the ends 153, 154 of the tube 148.

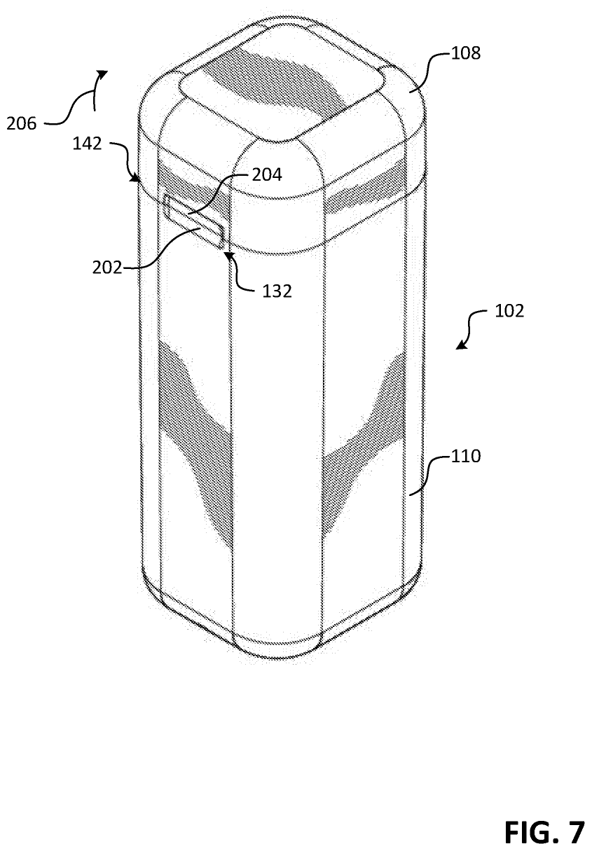

FIG. 7 is an isometric view of the storage case 102 with the lid 108 in the closed position. In the example shown, the lid 108 and the base 110 include indentations 202, 204 that open into one another and allow a user to place their fingernail within the indentations 202, 204 and open the lid 108 by urging the lid 108 in a direction generally indicated by arrow 206.

The storage case 102 may have a height of about 5.5 cm and/or may be made from and/or may include materials including for example plastic, wood, metal, and/or a composite. Some of these materials may include recycled materials, bio-plastics, plant-based plastics, woods, metals, composite materials, plant-based composite such as for example a wheat-flaxseed-bamboo based composite and others, recycled ABS plastic injection molded materials, metal hinges, neodymium magnets, and glue.

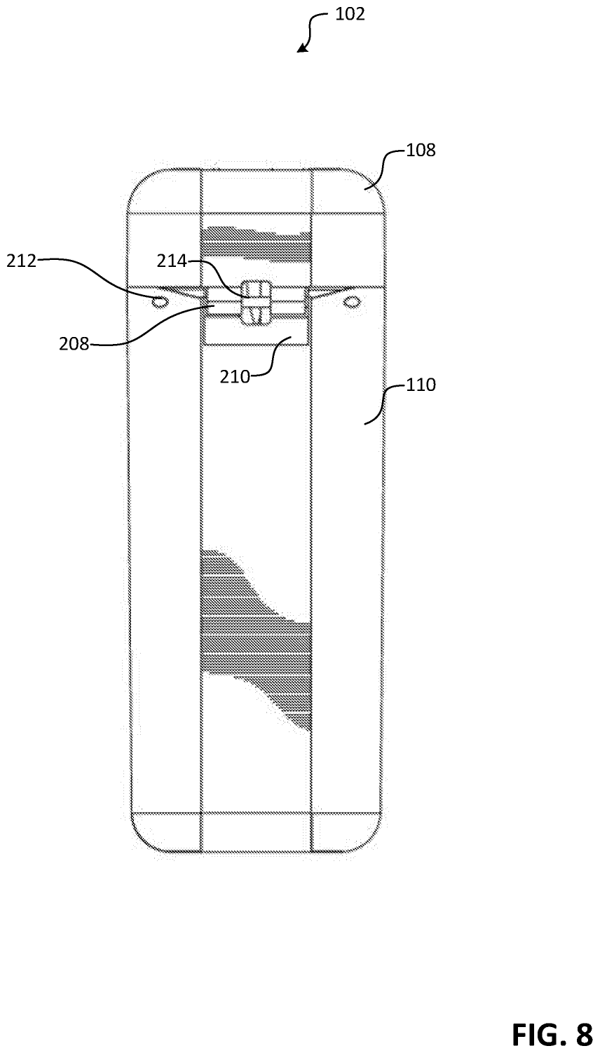

FIG. 8 is a rear view of the storage case 102 of FIG. 7. In the example shown, the lid 108 is hingably coupled to the base 110. To provide the hinged coupling, in the example shown, the lid 108 includes a tab 208 that is positioned within a cut-out 210 defined by the base 110 and a pin 212 extends through the lid 108 and the base 110 to couple the lid 108 and the base 110 together. The tab 208 may define an aperture 214 through which a strap (not shown) may extend to allow the system 100 to be coupled to a keychain, for example. However, the system 100 may be coupled to a keychain and/or a lanyard in different ways.

Although the foregoing text discloses a detailed description of example methods, apparatus, and/or articles of manufacture, it should be understood that the legal scope of the property right is defined by the words of the claims set forth at the end of this patent. Accordingly, the following detailed description is to be construed as examples only and does not describe every possible example, as describing every possible example would be impractical, if not impossible. Numerous alternative examples could be implemented, using either current technology or technology developed after the filing date of this patent. It is envisioned that such alternative examples would still fall within the scope of the claims.

Further, while several examples have been disclosed herein, any features from any examples may be combined with or replaced by other features from other examples. Moreover, while several examples have been disclosed herein, changes may be made to the disclosed examples without departing from the scope of the claims.

1. A system for drinking liquids, comprising:
a storage case having a lid and a base defining an internal cavity including a straw storing area and a cleaning element storing area;
a reusable drinking straw comprising a flexible tube having a passageway, a proximal end, and a distal end, wherein the reusable drinking straw is configured to move from a folded configuration to an extended configuration based on an elasticity of the flexible tube,
wherein when in the folded configuration, the reusable drinking straw having a plurality of segments arranged beside one another and being disposable within the straw storing area and, when in the extended configuration, the reusable drinking straw being generally linear; and
a cleaning element comprising a brush and being disposable within the cleaning element storing area and adapted to clean the passageway of the flexible tube.

2. The system of claim 1, wherein the reusable drinking straw further comprises a plurality of tubular segments disposed between the proximal end and the distal end of the reusable drinking straw and through which the flexible tubing extends.

3. The system of claim 1, wherein a removable coupling is formed between the cleaning element and the storage case when the cleaning element is disposed within the cleaning element storing area.

4. The system of claim 3, wherein the removable coupling is a magnetic coupling.

5. The system of claim 1, wherein the cleaning element comprises a cleaning element magnet and the storage case comprises a storage case magnet that is attracted to the cleaning element magnet.

6. The system of claim 5, wherein the cleaning element is movable between a collapsed position and an extended position, wherein the attraction between the cleaning element magnet and the storage case magnet allows the cleaning element to be moved from the collapsed position to the extended position while retaining a relative position of the brush within the cleaning element storing area.

7. The system of claim 6, wherein the cleaning element has an end comprising the cleaning element magnet.

8. The system of claim 1, wherein a snap-fit connection is formed between the cleaning element and the storage case when the cleaning element is disposed within the cleaning element storing area.

9. The system of claim 1, wherein the cleaning element comprises a telescopic handle coupled to the brush, wherein the handle is movable between a collapsed position for storage within the cleaning element storing area and an extended position to clean the passageway of the flexible tube.

10. The system of claim 9, wherein the handle has a proximal end having a grasping flange.

11. The system of claim 1, wherein the handle has a proximal end having a shoulder that is adapted to engage the proximal end or the distal end of the flexible tube.

12. The system of claim 1, wherein the straw storing area is contiguous with the cleaning element storing area.

13. The system of claim 1, wherein the base has a front wall that defines an internal longitudinal groove that at least partially forms the cleaning element storing area.

14. The system of claim 1, wherein the base of the storage case has an internal wall that separates the straw storing area and the cleaning element storing area.

15. The system of claim 1, wherein a magnetic coupling is formed between the lid and the base when the lid is in a closed position.

16. The system of claim 1, wherein the base defines an inner circumferential groove at an opening of the internal cavity and the lid comprises a rib that is adapted to be received within the circumferential groove and form a seal when the lid is in a closed position.

17. The system of claim 1, wherein the lid comprises a key ring.

18. The system of claim 2, wherein the flexible tube is under tension within the plurality of tubular segments.

19. The system of claim 1, wherein the flexible tube is in a stretched state in the folded configuration and the flexible tube is in a less-stretched state in the extended configuration.

20. The system of claim 2, wherein in the extended configuration, the plurality of tubular segments are generally coaxially arranged.

21-28. (canceled)
